(19) United States
(12) Patent Application Publication
(10) Pub. No.: US 2010/0077673 A1
(43) Pub. Date: Apr. 1, 2010

(54) ANTILOADING COMPOSITION FOR AN ABRASIVE ARTICLE AND ABRASIVE ARTICLE HAVING AN ANTILOADING COATING

(76) Inventors: Hitoshi Oka, Tokyo (JP); Satoru Takinami, Kanagawa (JP)

Correspondence Address: 3M INNOVATIVE PROPERTIES COMPANY, PO BOX 33427, ST. PAUL, MN, 55133-3427, US

(21) Appl. No.: 12/594,611

(22) PCT Filed: Mar. 25, 2008
(86) PCT No.: PCT/US08/58095

§ 371 Date: Oct. 5, 2009

(30) Foreign Application Priority Data
Apr. 18, 2007 (JP) 2007-108849

(51) Int. Cl. C08K 5/09; B24D 11/00

(52) U.S. Cl. 51/295; 524/394

(57) ABSTRACT

To improve the endurance of the antiloading effect of an antiloading composition for an abrasive article. The antiloading composition for an abrasive article, comprising a metal salt of a fatty acid and a binding resin, wherein a coating formed therefrom has wetting tension of more than 44 mN/m.

### TECHNICAL FIELD

The present invention relates to an antiloading composition for an abrasive article, and an abrasive article having an antiloading coating.

### BACKGROUND ART

Abrasive articles have conventionally been used for abrading (sanding) various substrates, or workpieces, and the like. There is a problem of “loading” as one of the problems occurring during sanding. That is, swarf abraded from a workpiece accumulates between abrasive particles, thereby causing deterioration of cutting ability and performances of an abrasive article, even though the abrasive particles are not abraded.

Therefore, in the abrasive article industry, the use of antiloading compositions in abrasive articles has been studied. For example, metal salts of fatty acids used as antiloading agents in the antiloading compositions, are known.

### DISCLOSURE OF INVENTION

The antiloading agents, that is, the metal salts of fatty acids described in the art exhibit good antiloading properties, and thus make it possible to obtain abrasive articles having excellent sanding performance. However, it has become apparent that, depending on the sanding conditions, these antiloading agents are removed from the surface of abrasive articles.

It is thought that when the antiloading agent is removed from the surface of an abrasive article, it does so together with abraded swarf, and thus loading of swarf in the abrasive article is prevented. However, as the level of antiloading agent on the surface of the abrasive article decreases, the abrasive swarf is apt to accumulate between abrasive particles, which makes it difficult to maintain intrinsic cutting performance of the abrasive article.

Therefore, in order to exert a good antiloading effect and maintain intrinsic cutting performance of an abrasive article, it is preferable to periodically replace the abrasive article when too much antiloading agent is lost from the surface of the abrasive article. However, since replacement of an abrasive article is complicated, it has recently been required to develop an abrasive article that maintains total cut and has a improved cut-life, thus realizing material cost savings and a reduction in environmental waste. In fact, it is said that sanding operators sense deterioration of sanding performance when the cut-life decreases by about 15 to 20%. Therefore, abrasive articles capable of sustaining at least 80% or more of cut-life as long as possible are strongly demanded in the marketplace.

The present inventors have studied on the relation between “antiloading properties” and “exfoliation, or removal, resistance from an abrasive surface” of antiloading agent applied to abrasive articles, and found that both “antiloading properties” and “exfoliation resistance from an abrasive surface” can be satisfied by controlling the “wetting tension” of a metal salt of a fatty acid contained in the antiloading composition.

That is, the present invention is an antiloading composition for an abrasive article, comprising a metal salt of a fatty acid and a binding resin, wherein a coating formed therefrom has wetting tension of more than 44 mN/m.

Also, the present invention provides an abrasive article having an antiloading coating formed from the antiloading composition on the abrasive surface.

In the present invention, the use of a metal salt of a fatty acid having a specific wetting tension in the antiloading composition provides lubrication, and weak adhesion to, the abraded swarf. In addition to imparting good antiloading properties to the abrasive article, the antiloading composition remains anchored to the surface of the abrasive article, thus reducing exfoliation of the antiloading agent from the abrasive surface. Consequently, the total cut is maintained and the cut-life of the abrasive article is extended. The useful life of the abrasive article can therefore be markedly improved.

### BRIEF EXPLANATION OF DRAWINGS

FIG. 1 is a plot of the change in cut-life after each sanding cycle.

FIG. 2 is a plot of the relationship between the cut-life of the abrasive article and the wetting tension of the antiloading composition.

FIG. 3 is a micrograph showing the abrasive surface of an abrasive article prepared in Example 1 after the 5-cycle sanding test.

FIG. 4 is a micrograph showing the abrasive surface of an abrasive article prepared in Comparative Example 4 after the 5-cycle sanding test.

### DETAILED DESCRIPTION

### Antiloading Composition

The antiloading composition of the present invention denotes a composition containing a metal salt of a fatty acid serving as an antiloading agent and a binding resin. In addition, the antiloading composition to be used as an antiloading coating formed therefrom has a specific wetting tension.

It is known to use metal salts of fatty acids with low wetting tension and poor adhesion in abrasive articles. It has been thought that, due to the low surface tension, the abrasive swarf does not adhere to the antiloading agent, and therefore loading is prevented. However, the low surface tension also means the antiloading composition has weak adhesion to the surface of the abrasive article, and therefore is apt to be removed from the abrasive surface by a frictional force or the like during the sanding operation. On the contrary, in the present invention, the antiloading composition has higher wetting tension. By using such an antiloading composition, the antiloading layer is not easily removed from the surface of the abrasive article even in continuous abrading operations, and the abrasive article can maintain superior sanding performance for a longer time.

Specifically, the lower limit of wetting tension of the antiloading composition is determined on the basis of adhesion of the antiloading composition to a surface of the abrasive article (the abrasive surface). In the present invention, the antiloading layer has wetting tension of more than 44 mN/m, as measured in accordance with the method described in JIS K 6768 (ASTM D-2578). When the wetting tension of the antiloading layer is 44 mN/m or less, it is easily removed from the abrasive surface and thus the antiloading effect is minimized. The wetting tension of the antiloading layer is 47 mN/m or more in one embodiment, 50 mN/m or more in a further embodiment, and 52 mN/m in another embodiment in light of the adherence to the abrasive surface, or the improved cut-life, of the abrasive article. In the case where the wetting tension of the antiloading composition is 47 mN/m or more, cut-life greater than 85% and 90% or greater, can be achieved over a long period of time.

The upper limit of wetting tension is determined appropriately on the grounds of adhesiveness of abrasive swarf to the antiloading composition. In other words, the upper limit of wetting tension relates to the wetting tension of to the workpiece be abraded. However, it is difficult to determine the upper limit of wetting tension unilaterally because of the variety of workpieces that may be abraded. Generally, when the workpiece is a resin material such as putty used for repairing car bodies and coatings, a preferable upper limit of wetting tension is 60 mN/m, and more preferably 56 mN/m.

A metal salt of a fatty acid as described in the present invention indicates a metal salt of a long chain fatty acid. Although there is no specific limitation on the types of fatty acids, metal salts of fatty acids staying solid in room temperature are preferred, and those having 8 or more carbon atoms are preferably used. Examples of saturated fatty acids that may be used include caprylic acid, capric acid, lauric acid, myristic acid, palmitic acid, stearic acid, arachidic acid, behenic acid, lignoceric acid and montanic acid. Examples of unsaturated fatty acids include sebacic acid, undecylenic acid, decenoic acid, oleic acid, erucic acid, linoleic acid, linolenic acid and arachidonic acid. Among them, preferred fatty acids are capric acid, lauric acid, myristic acid, palmitic acid, stearic acid, behenic acid, montanic acid, sebacic acid and undecylenic acid, and more preferably stearic acid, palmitic acid, myristic acid, lauric acid, behenic acid and montanic acid.

Examples of metals composing the salt of the fatty acid include calcium, zinc, magnesium, aluminum, barium, lithium, sodium, potassium, calcium and silver. Preferred metals include calcium, zinc and magnesium.

In order to confine the wetting tension of the antiloading composition to the specific range determined in the present invention as described above, for example, such measures as providing a metal salt of a fatty acid with polar groups in a region of hydrocarbon of a fatty acid, and adjusting the kinds of the polar groups, number and content or controlling the proportion of the metal salt of a fatty acid to a binding resin by quantity are exemplified. Also, a plurality of different metal salts of fatty acids enables the wetting tension of the antiloading composition to be controlled.

The use of polar groups in the hydrocarbon chain of metal salt of the fatty acid is preferred because the number, kind and content of the polar groups in a molecule may be adjusted in order to easily control the wetting tension of the antiloading composition.

Examples of polar groups include hydroxyl, carboxyl, amino, aldehyde, nitro, nitrile, isocyanate, sulfone and thiol groups. Preferred groups include hydroxyl capable of discharging a proton, carboxyl, amino, aldehyde, sulfone and thiol groups. A particularly preferred polar group is a hydroxyl group. The number of polar groups in the metal salt of the fatty acid molecule may be appropriately determined according to the value of wetting tension of the antiloading composition, and a single polar group may provide the appropriate wetting tension in some cases.

In the present invention, particularly preferred metal salts of fatty acids include metal salts of 12-hydroxystearic acid, ricinoleic acid, 2-hydroxyoctanoic acid and 2-hydroxyhexadecanoic acid. Among others, a metal salt of 12-hydroxystearic acid is most preferred.

A binding resin used for the antiloading composition of the present invention will now be described. Conventionally used resins or rubbers can serve as the binding resin, and there is no specific limitation. Examples thereof include alkylcellulose resins such as methylcellulose and ethylcellulose, acrylic resin, alkylamide resin, vinyl acetate resin, styrene-acrylonitrile resin, styrenebutadiene rubber, butadiene rubber, natural rubber, chloroprene rubber and methylbutadiene rubber. Two or more binding resins may be used in combination.

The antiloading composition of the present invention may be prepared by mixing a metal salt of a fatty acid and a binding resin. A liquid medium may further be added to the antiloading composition, if necessary. With regard to the liquid medium, an aqueous medium consisting mainly of water can be exemplified, but it is not limited thereto. In addition, conventionally known additives may be, optionally, mixed therein, in an amount typically used. Examples of conventionally known additives include, surface-active agents, plasticizers, antistatic agents, humidifying agents, antifoaming agents, coloring materials, pigments, filler, and the like. Furthermore, each of the exemplary components may be in a pre-dispersed form for subsequent incorporation into the antiloading composition.

In the present invention, the content of the metal salt of a fatty acid in the antiloading composition for coating is in a range from 50 to 99% by dry weight basis in one embodiment. The content thereof is 60 to 95% in a further embodiment, and 70 to 90%, by dry weight in another embodiment. In the case where the amount of the antiloading agent in the antiloading coating is less than 50%, the antiloading effect is apt to decrease, while in the case where the amount exceeds 99%, the supporting property of the antiloading coating on the abrasive surface may be decreased in some cases.

### Abrasive Article

The abrasive article of the present invention has the antiloading composition thereof as described above on the abrasive surface. Specifically, it denotes an abrasive article with an abrasive surface on which a coating of the antiloading composition is applied. The antiloading coating may be applied to only on a portion of the abrasive surface so as not to cover some of the abrasive surface, such as apical regions of abrasive particles, or may be applied to the entire abrasive surface.

There is no specific limitation on how to apply the antiloading composition to the abrasive surface. For example, it may be applied by means of brush coating, roll coating, flow coating, die coating, spray coating and the like onto the abrasive surface of the abrasive article. Incidentally, the abrasive surface of an abrasive article denotes a surface thereof which exerts abrasive action by contacting a workpiece. The quantity of antiloading composition to be applied onto the abrasive surface can vary in an appropriate manner with the size and quantity of abrasive particles to be used and the intended application of the abrasive article. Generally, it is approximately 1 to 75 g/m² as dried coating weight, and preferably approximately 9 to 40 g/m².

After the antiloading composition is applied onto the abrasive surface, it may be heated and dried under proper conditions of temperature and time until the binding resin is formed into a film. The heating conditions may be determined in an appropriate manner.

The types of abrasive articles incorporating the present invention are not particularly limited, and may include those generally known to utilize conventional antiloading compositions. Examples of such abrasive articles may include, for example, bonded abrasive articles, coated abrasive articles and nonwoven abrasive articles.

For example, a bonded abrasive article comprises a multitude of abrasive particles bonded by a binding resin. A coated abrasive article comprises abrasive particles bonded to a substrate by a binding resin. A nonwoven abrasive article comprises abrasive particles bonded into or onto a three-dimensional nonwoven substrate by a binding resin. Each type of the abrasive articles may take a variety of forms. For example, a coated abrasive article may comprise a first layer (also known as a make coat), a plurality of abrasive particles bonded onto or into the first layer, and a second layer (also known as a size coat). In some cases, a third layer (also known as a supersize coat) may be applied onto the size coat. In addition, coated abrasive articles can be of various forms, for example, a belt, a disk or a sheet.

The abrasive article of the present invention having an antiloading coating on the abrasive surface can be used for abrading various workpieces, cellulose materials such as wood, fiberboards and particle boards, fiberglass, varnish, polyester coatings, stainless surfaces, car body fillers, ceramics, glass, paints including latexes and oil paints, primers including oil based primers and aqueous based primers, and metals such as aluminum, stainless steel and mild steel, and the like.

The present invention will now be specifically described by way of the following examples, but the present invention is not limited thereto. Parts and percentages in the examples are by weight unless otherwise specified.

### EXAMPLES

### Example 1

### Method of Making the Antiloading Composition

Calcium 12-hydroxystearate (“CS-6”, manufactured by NITTO CHEMICAL INDUSTRY CO. LTD., solid content: 30%) and methylcellulose (“Metolose SM-15”, manufactured by SHIN-ETSU CHEMICAL CO. LTD., solid content: 8%) were mixed with water and dispersed at 500 rpm using a mixer for 30 minutes to obtain the antiloading composition.

### Measurement of Wetting Tension

The wetting tension of a coating formed from the obtained antiloading composition was measured in accordance with JIS K 6768 “Test Method for Wetting Tension of Plastic, Film and Sheet”, the disclosure of which is incorporated herein by reference. As a result, the film thickness of the antiloading coating was determined to be 35 micrometers (μm). In addition, the quantity of the antiloading composition to be applied, and the appropriate drying conditions, were determined according to the specific compositions described below. The measurements are listed in Table 3.

### Method of Making Abrasive Article Having Antiloading Coating

The antiloading composition was applied to the size coated surface of a coated abrasive article, “Uni” (P120 grade) manufactured by 3M LTD., using a hand rubber roll. The coated material was then placed in an oven set at 120° C. for 2.5 minutes, after which the coated abrasive article was removed and cooled. The quantity of antiloading composition applied was approximately 0.2 grams dry coat weight per 4 inches×6 inches (10.2×15.2 cm).

### Sanding Test

The resulting abrasive article having the antiloading coating was stamped into a test disk having a diameter of 125 mm and subsequently attached to an air sander, model “Double Action Sander 3965” manufactured by 3M LTD. A putty, “FS Middle” manufactured by KANSAI PAINT CO. LTD. was applied onto a steel panel substrate, dried and cured. The cured putty was then sanded, under a load of approximately 2 kg, for 5 cycles, 3 minutes per cycle.

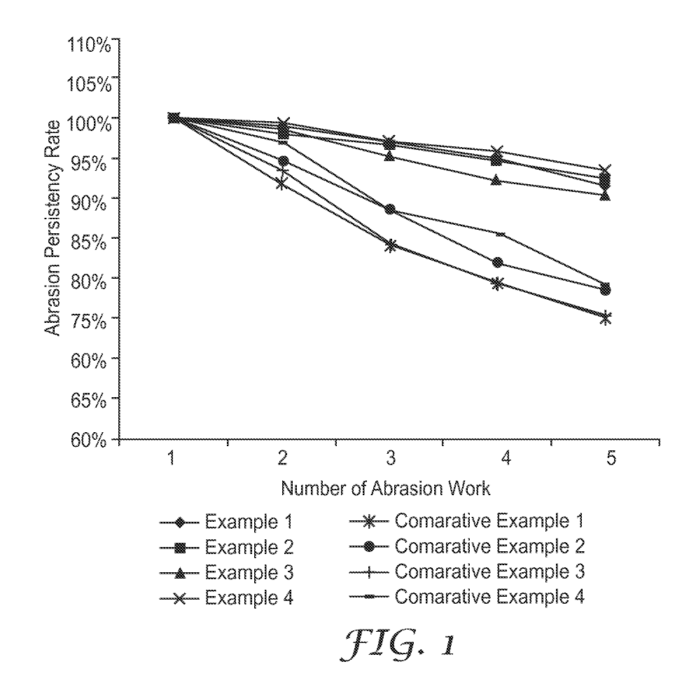

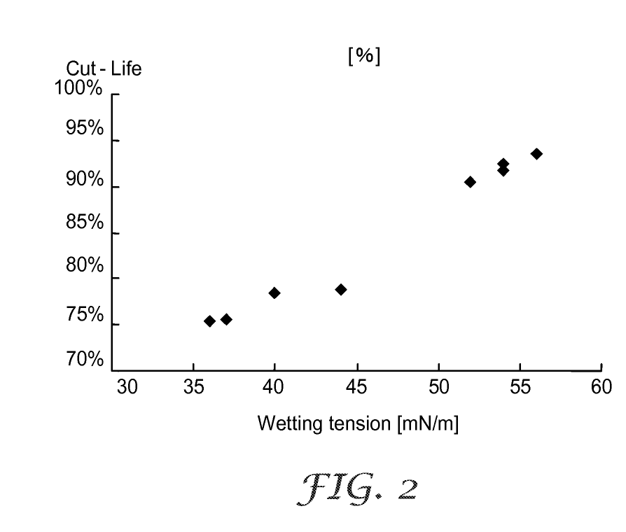

The total cut and the cut-life results are shown in Table 3. The total cut is the amount, in grams, of material removed from the workpiece after 5 sanding cycles of 3 minutes each. The cut-life is the change, expressed as percent, of the cut after each sanding cycle. FIG. 1 is a plot of the change in cut-life after each sanding cycle. FIG. 2 is a plot of the relationship between the cut-life of the abrasive article and the wetting tension of the antiloading composition.

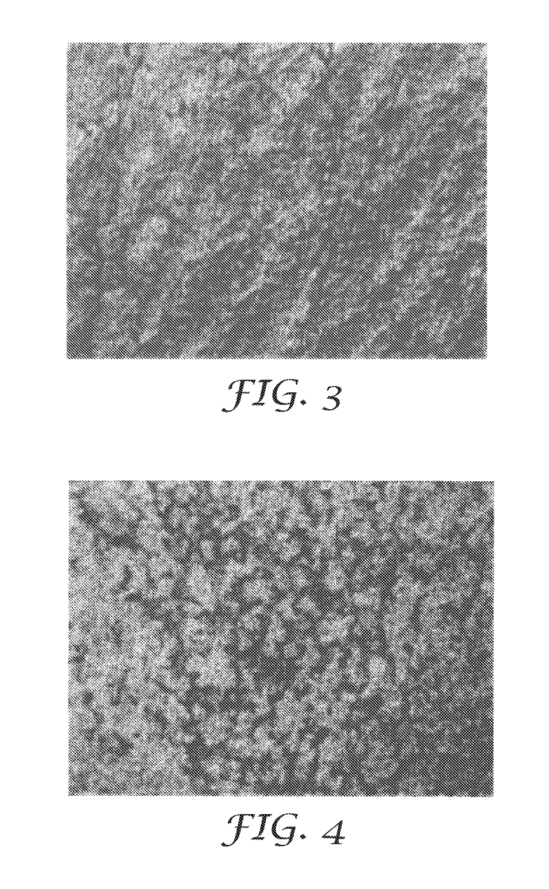

FIG. 3 is a photomicrograph of Example 1 after 5 sanding cycles, showing that the antiloading coating remains on the abrasive surface.

### Examples 2 to 4

Abrasive articles were prepared according to the method described in Example 1, except the antiloading compositions were modified as listed in Table 1. The quantity of the components shown in Table 1 are by dry weight percent and the remaining component is water. The wetting tension of the antiloading coatings, the total cut and the cut-life are listed in Table 3. The cut-life per sanding cycle of these Examples are plotted in FIG. 1, while the relationship between the cut-life and the wetting tension of the antiloading compositions is plotted in FIG. 2.

TABLE 1

| | | Example 1 | Example 2 | Example 3 | Example 4 |
|---|---|---|---|---|---|
| Metal Salt | Calcium 12-hydroxystearate¹⁾ | 30 | — | — | — |
| of a fatty | Zinc | — | 30 | — | — |
| acid | 12-hydroxystearate²⁾ | | | | |
| | Magnesium | — | — | 30 | — |
| | 12-hydroxystearate³⁾ | | | | |
| | Calcium | — | — | — | 40 |
| | 12-hydroxystearate | | | | |
| | (Dispersed in water)⁴⁾ | | | | |
| Binding | Methylcellulose⁵⁾ | 8 | 8 | 8 | — |
| Resin | Styrene-Acrylonitrile | — | — | — | 10 |
| | Emulsion⁶⁾ | | | | |

¹⁾“CS-6” manufactured by NITTO CHEMICAL INDUSTRY CO. LTD.
²⁾“ZS-6” manufactured by NITTO CHEMICAL INDUSTRY CO. LTD.
³⁾“MS-6” manufactured by NITTO CHEMICAL INDUSTRY CO. LTD.
⁴⁾“CSE-6” manufactured by NITTO CHEMICAL INDUSTRY CO. LTD.
⁵⁾“Metolose SM-15”, manufactured by SHIN-ETSU CHEMICAL CO. LTD.
⁶⁾“Nipol LX311”, manufactured by ZEON CORPORATION.

### Comparative Examples 1 to 4

Comparative abrasive articles were prepared according to the method described in Example 1, except the antiloading compositions were modified as listed in Table 2. The wetting tension of the Comparative antiloading coatings, the total cut and the cut-life are listed in Table 3. The cut-life per sanding cycle of these Examples are plotted in FIG. 1, while the relationship between the cut-life and the wetting tension of the antiloading compositions is plotted in FIG. 2.

TABLE 2

| | | Comparative | Comparative | Comparative | Comparative |
|---|---|---|---|---|---|
| | | Example 1 | Example 2 | Example 3 | Example 4 |
| Metal Salt of | Zinc | 30 | — | — | — |
| a fatty acid | Stearate¹⁾ | | | | |
| | Calcium | — | 30 | — | — |
| | Stearate²⁾ | | | | |
| | Lithium | — | — | 30 | — |
| | Stearate³⁾ | | | | |
| | Calcium | — | — | — | 40 |
| | Stearate | | | | |
| | (Dispersed in water)⁴⁾ | | | | |
| Binding Resin | Methyl- | 8 | 8 | 8 | — |
| | cellulose⁵⁾ | | | | |
| | Styrene- | — | — | — | 10 |
| | Acrylonitrile | | | | |
| | Emulsion⁶⁾ | | | | |

¹⁾“Zn-St” manufactured by NITTO CHEMICAL INDUSTRY CO. LTD.
²⁾“Ca-St” manufactured by NITTO CHEMICAL INDUSTRY CO. LTD.
³⁾“Li-St” manufactured by NITTO CHEMICAL INDUSTRY CO. LTD.
⁴⁾“NOPCO 1097AH” manufactured by SAN NOPCO LTD.
⁵⁾“Metolose SM-15”, manufactured by SHIN-ETSU CHEMICAL CO. LTD.
⁶⁾“Nipol LX311”, manufactured by ZEON CORPORATION.

According to the test results, the abrasive articles prepared in Examples 1-4 showed greater total cut and better cut-life versus the Comparative Examples.

TABLE 3

| | Wetting | | |
|---|---|---|---|
| | tension | Total Cut | Cut-Life |
| | (mN/m) | (grams) | (%, after 5 sanding cycles) |
| Example 1 | 54 | 145.0 | 92 |
| Example 2 | 54 | 146.0 | 92 |
| Example 3 | 52 | 141.1 | 91 |
| Example 4 | 56 | 151.5 | 94 |
| Comparative | 36 | 120.7 | 75 |
| Example 1 | | | |
| Comparative | 40 | 116.9 | 79 |
| Example 2 | | | |
| Comparative | 37 | 109.3 | 76 |
| Example 3 | | | |
| Comparative | 44 | 127.1 | 79 |
| Example 4 | | | |

FIG. 3 is a photomicrograph of Example 1 after 5 sanding cycles, showing that no antiloading coating remains on the abrasive surface.

What is claimed is:

1. An antiloading composition for an abrasive article, comprising a metal salt of a fatty acid and a binding resin, wherein a coating formed therefrom has wetting tension of more than 44 mN/m.

2. The antiloading composition for an abrasive article according to claim 1, wherein the content of the metal salt of a fatty acid in the antiloading composition is in a range from 50 to 99% by weight based on the solid content.

3. The antiloading composition for an abrasive article according to claim 1, wherein the metal salt of a fatty acid has polar groups in the hydrocarbon moiety of the fatty acid.

4. The antiloading composition according to claim 1, wherein the metal salt of a fatty acid is metal salt of 12-hydroxystearic acid.

5. The abrasive article having an antiloading coating, which is formed from the antiloading composition according to any one of claims 1 to 4, on an abrasive surface.
